(19) United States
(12) Patent Application Publication
(10) Pub. No.: US 2021/0197389 A1
(43) Pub. Date: Jul. 1, 2021

(54) COMPUTER DEVICE AND METHOD FOR CONTROLLING ROBOTIC ARM TO GRASP AND PLACE OBJECTS

(71) Applicant: Chiun Mai Communication Systems, Inc., New Taipei (TW)

(72) Inventor: TUNG-CHUN HSIEH, New Taipei (TW)

(21) Appl. No.: 17/136,934

(22) Filed: Dec. 29, 2020

(30) Foreign Application Priority Data
Dec. 30, 2019 (CN) 201911402803.9

(51) Int. Cl. B25J 9/16; G06K 9/62; G06K 9/00; G06T 7/55; G06T 7/73; B25J 13/08

(52) U.S. Cl. CPC B25J 9/1697; G06K 9/6289; G06K 9/6202; G06K 9/00664; G06T 7/55; G06T 2207/20221; B25J 9/1664; B25J 13/08; G06T 2207/10028; G06T 2207/10024; G06T 7/73

(57) ABSTRACT

A method for controlling a robotic arm to grasp and place objects includes acquiring a plurality of sets of images each of which including an RGB image and a depth image. The RGB image and the depth image of each set are associated with each other. A plurality of fused images are obtained by fusing of depth information on each RGB image based on depth information of corresponding depth image. Once a three-dimensional map is constructed based on the plurality of fused images, a robotic arm is controlled to grasp and place objects based on the three-dimensional map.

### FIELD

The present disclosure relates to robot control technology, in particular to a computer device and a method for controlling robotic arm to grasp and place objects.

### BACKGROUND

Currently, a robotic arm requires a complex and long-term installation and set-up by professional and well-trained engineers. In addition, the robotic arm has difficulties in grasping and placing objects in various environments.

### BRIEF DESCRIPTION OF THE DRAWINGS

FIG. 1 is a flowchart of a method for constructing a three-dimensional map provided by a preferred embodiment of the present disclosure.

FIG. 2 is a flowchart of a method for controlling a robotic arm to grasp and place an object according to a preferred embodiment of the present disclosure.

FIG. 3 is a block diagram of a control system provided by a preferred embodiment of the present disclosure.

FIG. 4 is a schematic diagram of a computer device and a robotic arm provided by a preferred embodiment of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

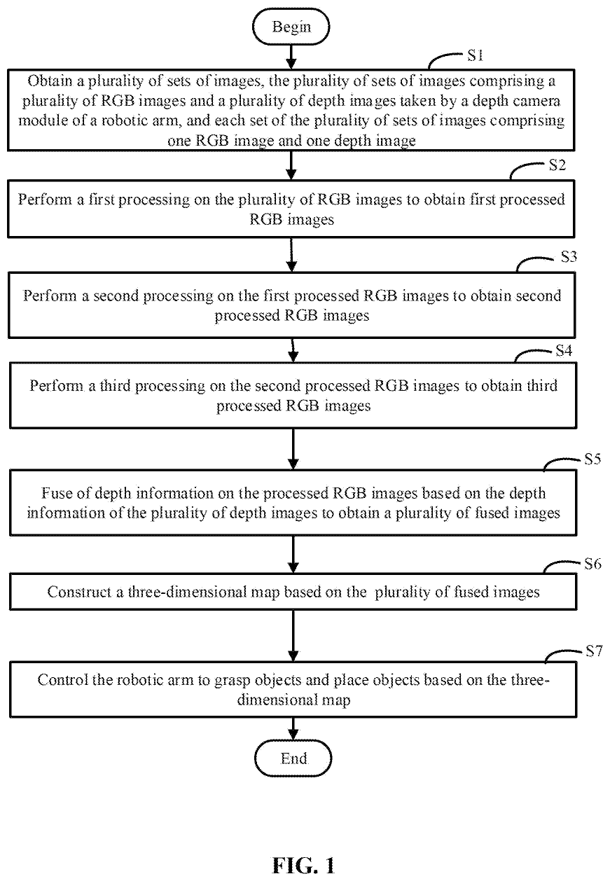

FIG. 1 shows a flowchart of a method for constructing a three-dimensional map provided by a preferred embodiment of the present disclosure.

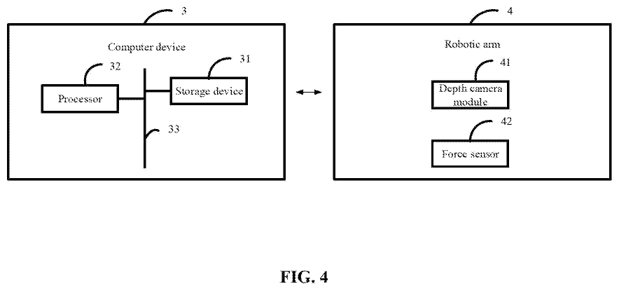

In one embodiment, the method for constructing the three-dimensional map can be applied to a computer device (e.g., a computer device 3 in FIG. 4). For a computer device that needs to perform the method for constructing the three-dimensional map, the function for constructing the three-dimensional map can be directly integrated on the computer device, or run on the computer device in the form of a software development kit (SDK).

At block S1, the computer device obtains a plurality of sets of images, each set of the plurality of sets of images includes one RGB image and one depth image that are taken by a depth camera module of a robotic arm. The depth camera module includes a RGB camera and a depth camera. Therefore, the plurality of sets of images taken by the depth camera module include a plurality of RGB images and a plurality of depth images. The computer device associates the one RGB image with the one depth image of the each set of the plurality of sets of images. That is, each RGB image corresponds to each depth image.

In this embodiment, the computer device controls the robotic arm rotates within a first preset angle range, and each time when the robotic arm have rotated a second preset angle, the computer device controls the robotic arm to capture the RGB image and the depth image, such that the plurality of RGB images and the plurality of depth images are obtained.

In this embodiment, the one RGB image and the one depth image included in each set are captured simultaneously by the depth camera module. That is, the capturing time of the one RGB image and the capturing time of the one depth image included in each set are the same.

In one embodiment, the first preset angle range is 360 degrees. The second preset angle is 30 degrees, 60 degrees or another angle value.

For example, the computer device can control the depth camera module to capture a current scene every time after the depth camera module rotates 30 degrees clockwise, such that the RGB image and the depth image of the current scene are obtained.

In one embodiment, the depth camera module is installed at an end of the robotic arm.

At block S2, the computer device performs a first processing on the plurality of RGB images, and obtains first processed RGB images. The first processing includes: performing feature point matching on each two adjacent RGB images of the plurality of RGB images using a SURF algorithm.

In this embodiment, the two adjacent RGB images may refer to two RGB images having adjacent capturing time.

For example, suppose the depth camera module has successively captured three RGB images, namely R1, R2, and R3. That is, R1 and R2 are two adjacent RGB images, and R2 and R3 are two adjacent RGB images. Then the computer device applies the SURF algorithm to make feature point matching on R1 and R2, and make feature point matching on R2 and R3.

At block S3, the computer device performs a second processing on the first processed RGB images, and obtains second processed RGB images. The second processing includes: confirming whether the feature point matching has been correctly performed on each two adjacent RGB images of the first processed RGB images, and eliminating wrongly matched feature point.

At block S4, the computer device performs a third processing on the second processed RGB images, and obtains third processed RGB images. The third processing includes: calculating a graphic angle difference of each two adjacent RGB images of the second processed RGB images using a RANSAC algorithm, and making the graphic angle of each two adjacent RGB images the same, by correspondingly correcting one of the each two adjacent RGB images based on the graphic angle difference.

In one embodiment, the corrected RGB image (i.e., the one of the each two adjacent RGB images that is corrected based on the graphic angle difference) is the RGB image of each two adjacent RGB images of which the capturing time is later.

For example, it is still assumed that the depth camera module has successively captured the three RGB images, namely R1, R2, and R3. After the second processing is performed on R1, R2, and R3, the computer device can calculate a first graphic angle difference between R1 and R2 use the RANSAC algorithm. The computer device can correct R2 based on the first graphic angle difference so that the graphic angles of R1 and R2 are the same. The computer device can calculate a second graphic angle difference between R2 and R3 use the RANSAC algorithm, and correct R3 based on the second graphic angle difference so that the graphic angles of R2 and R3 are the same.

At block S5, the computer device fuses of depth information on the third processed RGB images based on the depth information of the plurality of depth images, thereby obtains a plurality of fused images.

Each fused image of the plurality of fused images refers to a third processed RGB image that is fused with depth information of a corresponding depth image. That is, the fused image contains both depth information and color information.

In this embodiment, the computer device may overlap the pixel value of each third processed RGB image and the depth value of the corresponding depth image by 1:1.

For example, assuming that coordinates of a pixel point p1 of the third processed RGB image is (xx1, yy1), and a depth value of the pixel point p1 of the corresponding depth image is d, when the pixel value of the third processed RGB image and the depth value of the corresponding depth image are overlapped 1:1, the coordinates of the pixel point p1 of the fused image is (xx1, yy1, d). That is, xx1 is an abscissa of the pixel point p1 of the fused image, yy1 is an ordinate of the pixel point p1 of the fused image, and d is a vertical coordinate of the pixel point p1 of the fused image.

At block S6, the computer device constructs a three-dimensional map based on the plurality of fused images, and stores the three-dimensional map. For example, the three-dimensional map is stored in a storage device of the computer device.

In an embodiment, the computer device may construct the three-dimensional map based on the depth information of each of the plurality of fused images.

In an embodiment, the construction of the three-dimensional map based on the plurality of fused images includes (a1)-(a2):

(a1) calculating three-dimensional coordinates of each pixel point of each fused image of the plurality of fused images in a physical space.

In an embodiment, the three-dimensional coordinates of each pixel point of each fused image in the physical space refer to the coordinates of each pixel point of each fused image in a coordinate system of the physical space.

In this embodiment, the computer device establishes the coordinate system of the physical space, including: setting a position of the depth camera module as an origin O, setting a horizontal direction towards right as an X axis, setting a vertical direction upwards as a Z axis, and setting a direction vertical to a XOZ plane as a Y axis.

In this embodiment, the computer device can calculate the three-dimensional coordinates of each pixel point of each fused image in the physical space using the principle of Gaussian optics.

For example, it is assumed that the coordinates of each pixel point p1 of the fused image is (xx1, yy1, d), and the coordinates of the pixel point p1 of the coordinate system of the physical space is (x1, y1, z1). Suppose that a focal length of the RGB camera of the depth camera module on the x-axis of the coordinate system is fx, and the focal length of the RGB camera of depth camera module of on the y-axis is fy; and a distance from a center of an aperture of the RGB camera of depth camera module to the x-axis is cx, a distance from the center of the aperture of the RGB camera of depth camera module to the y axis is cy; and a zoom value of the RGB camera of depth camera module is s. That is, fx, fy, cx, cy, s are all known values. Then z1=d/s; x1=(xx1−cx)*z1/fx; y1=(yy1−cy)*z1/fy. Thus, the three-dimensional coordinates of each pixel point of each fused image in the physical space can be calculated.

(a2) associating each fused image with the three-dimensional coordinates of each pixel point of the each fused image, and stitching the plurality of fused images, thereby obtaining the three-dimensional map.

In one embodiment, the computer device may stitch the plurality of fused images using a method based on features, a method based on stream, and a method based on phase correlation.

At block S7, the computer device controls the robotic arm to grasp objects and place objects based on the three-dimensional map.

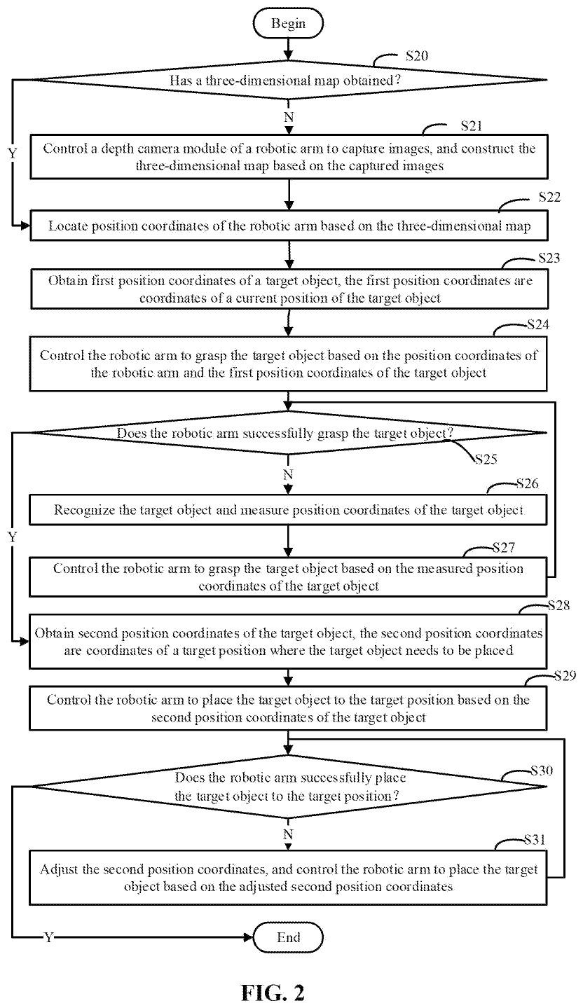

In this embodiment, the method for controlling the robotic arm to grasp and place objects based on the three-dimensional map can refer to the below description of FIG. 2.

FIG. 2 is a flowchart of a method for controlling a robotic arm to grasp and place an object according to a preferred embodiment of the present disclosure.

In one embodiment, the method for controlling the robotic arm to grasp and place an object can be applied to a computer device (e.g., a computer device 3 in FIG. 4). For a computer device that needs to perform the method for controlling the robotic arm to grasp and place an object, the function for controlling the robotic arm to grasp and place an object can be directly integrated on the computer device, or run on the computer device in the form of a software development kit (SDK).

At block S20, the computer device determines whether the three-dimensional map has been obtained. When the three-dimensional map has not been obtained, the process goes to block S21. When the three-dimensional map has been obtained, the process goes to block S22.

Specifically, the computer device can query whether the three-dimensional map exists in the storage device of the computer device.

At block S21, the computer device controls the depth camera module of the robotic arm to capture images, and constructs the three-dimensional map based on the captured images.

Specifically, the method of constructing the three-dimensional map is described in FIG. 1, i.e., the blocks S1 to S6 shown in FIG. 1.

At block S22, when the three-dimensional map has been obtained, the computer device locates position coordinates of the robotic arm based on the three-dimensional map.

In an embodiment, the computer device may use a preset algorithm such as a particle algorithm (Particle Filter), a Monte-Carlo method to estimate the position coordinates of the robotic arm in the three-dimensional map.

It should be noted that the particle algorithm is an algorithm based on the Monte-Carlo method. Specifically, each particle is used to represent an estimated posture visually seen on the three-dimensional map. When the robotic arm moves visually, it uses graphical feature point comparison to assign different weights to different particles. The wrong particle has a low weight and the correct particle has a high weight. After continuous recursive operations and re-sampling, patterns with high eigenvalues will be compared, and patterns with low eigenvalues will disappear (converge). Thus, the position coordinates of the robotic arm on the three-dimensional map are found. In other words, the computer device can use the Particle Filter and Monte-Carlo to estimate the position coordinates of the robotic arm in the three-dimensional map.

At block S23, the computer device obtains first position coordinates of a target object. The first position coordinates are coordinates of a current position of the target object.

In this embodiment, the target object is an object that is to be grasped by the robotic arm, and is to be placed in another location after being grasped by the robotic arm. The first position coordinates of the target object are coordinates in the three-dimensional map. The first position coordinates of the target object may be stored in the storage device of the computer device in advance. Therefore, when the target object needs to be grasped, the computer device can directly read the first position coordinates of the target object from the storage device.

At block S24, the computer device controls the robotic arm to grasp the target object based on the position coordinates of the robotic arm and the first position coordinates of the target object.

The computer device controls the robotic arm to move from the position of the robotic arm to the position of the target object, and then controls the robotic arm to grasp the target object.

At block S25, the computer device determines whether the robotic arm grasps the target object. When the robotic arm fails to grasp the target object, the process goes to block S26. When the robotic arm successfully grasps the target object, the process goes to block S28.

Specifically, the computer device can determine whether the robotic arm grasps the target object according to a weight detected by a force sensor on the robotic arm.

At block S26, when the robotic arm fails to grasp the target object, the computer device recognizes the target object and measures position coordinates of the target object, and obtains measured position coordinates of the target object. The process goes to block S27 after the block S26 is executed.

Specifically, the computer device may control the robotic arm to drive the depth camera module, and control the depth camera module to take a photo of the target object based on the first position coordinates of the target object, and identify the target object from the photo use a template matching method. The computer device may further use a template matching method to match the target object with the three-dimensional map, thereby identifying the target object in the three-dimensional map and obtaining the position coordinates of the target object in the three-dimensional map. The position coordinates of the target object in the three-dimensional map are used as measured position coordinates of the target object.

At block S27, the computer device controls the robotic arm to grasp the target object based on the measured position coordinates of the target object.

At block S28, when the robotic arm successfully grasps the target object, the computer device obtains second position coordinates of the target object. The second position coordinates are coordinates of a target position where the target object needs to be placed.

At block S29, the computer device controls the robotic arm to place the target object to the target position based on the second position coordinates of the target object.

At block S30, the computer device determines whether the robotic arm successfully places the target object to the target position. When the robotic arm successfully places the target object to the target position, the process ends. When the robotic arm fails to place the target object to the target position, the process goes to block S31.

Similarly, the computer device can determine whether the robot arm successfully places the target object to the target position according to the weight detected by the force sensor of the robotic arm.

At block S31, the computer device adjusts the second position coordinates, and controls the robotic arm to place the target object based on the adjusted second position coordinates.

In an embodiment, the computer device may adjust the second position coordinates according to a user operation signal. That is, the second position coordinates are adjusted according to user's input.

According to the above description, we can see that the present disclosure uses stereo vision or Lidar with RGB camera to allow the robotic arm to recognize its three-dimensional position in physical space and recognize the positions of target objects. In this way, the positioning of the robotic arm is simplified and the robotic arm can grasp different objects in physical space.

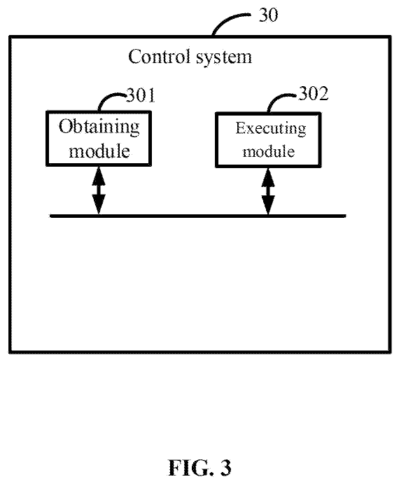

FIG. 3 shows a control system provided by a preferred embodiment of the present disclosure.

In some embodiments, the control system 30 runs in a computer device. The control system 30 may include a plurality of modules. The plurality of modules can comprise computerized instructions in a form of one or more computer-readable programs that can be stored in a non-transitory computer-readable medium (e.g., a storage device 31 of the computer device 3 in FIG. 4), and executed by at least one processor (e.g., a processor 32 in FIG. 4) of the computer device to implement the function described in detail in FIG. 1 and FIG. 2).

In at least one embodiment, the control system 30 may include a plurality of modules. The plurality of modules may include, but is not limited to, an obtaining module 301 and an executing module 302. The modules 301-302 can comprise computerized instructions in the form of one or more computer-readable programs that can be stored in the non-transitory computer-readable medium (e.g., the storage device 31 of the computer device 3), and executed by the at least one processor (e.g., a processor 32 in FIG. 3) of the computer device to implement a function of constructing a three-dimensional map and a function of controlling a robotic arm to grasp and place an object (e.g., described in detail in FIG. 1 and FIG. 2).

In order to explain the present invention clearly and simply, the functions of each module of the control system 30 will be specifically described below from the aspect of constructing a three-dimensional map.

The obtaining module 301 acquires a plurality of sets of images, each set of the plurality of sets of images includes one RGB image and one depth image that are taken by a depth camera module of a robotic arm. Therefore, the plurality of sets of images include a plurality of RGB images and a plurality of depth images. The executing module 302 associates the one RGB image with the one depth image of the each set of the plurality of sets of images. That is, each RGB image corresponds to each depth image.

In this embodiment, the executing module 302 controls the robotic arm rotates within a first preset angle range, and each time when the robotic arm have rotated a second preset angle, the executing module 302 controls the robotic arm to capture the RGB image and the depth image, such that the plurality of RGB images and the plurality of depth images are obtained.

In this embodiment, the one RGB image and the one depth image included in each set are captured simultaneously by the depth camera module. That is, the capturing time of the RGB image and the capturing time of the depth image included in each set are the same.

In one embodiment, the first preset angle range is 360 degrees. The second preset angle is 30 degrees, 60 degrees or another angle value.

For example, the obtaining module 301 can control the depth camera module to capture a current scene every time after the depth camera module rotates 30 degrees clockwise, such that the RGB image and the depth image of the current scene are obtained.

In one embodiment, the depth camera module is installed at an end of the robotic arm.

The executing module 302 performs a first processing on the plurality of RGB images, and obtains first processed RGB images. The first processing includes: performing feature point matching on each two adjacent RGB images of the plurality of RGB images using a SURF algorithm.

In this embodiment, the two adjacent RGB images may refer to two RGB images having adjacent capturing time.

For example, suppose the depth camera module has successively captured three RGB images, namely R1, R2, and R3. That is, R1 and R2 are two adjacent RGB images, and R2 and R3 are two adjacent RGB images. Then the executing module 302 applies the SURF algorithm to make feature point matching on R1 and R2, and make feature point matching on R2 and R3.

The executing module 302 performs a second processing on the first processed RGB images, and obtains second processed RGB images. The second processing includes: confirming whether the feature point matching has been correctly performed on each two adjacent RGB images of the first processed RGB images, and eliminating wrongly matched feature point.

The executing module 302 performs a third processing on the second processed RGB images, and obtains third processed RGB images. The third processing includes: calculating a graphic angle difference of each two adjacent RGB images of the second processed RGB images using a RANSAC algorithm, and making the graphic angle of each two adjacent RGB images the same, by correspondingly correcting one of the each two adjacent RGB images based on the graphic angle difference.

In one embodiment, the corrected RGB image (i.e., the one of the each two adjacent RGB images that is corrected based on the graphic angle difference) is the RGB image of each two adjacent RGB images of which the capturing time is later.

For example, it is still assumed that the depth camera module has successively captured the three RGB images, namely R1, R2, and R3. After the second processing is performed on R1, R2, and R3, the executing module 302 can calculate a first graphic angle difference between R1 and R2 use the RANSAC algorithm. The executing module 302 can correct R2 based on the first graphic angle difference so that the graphic angles of R1 and R2 are the same. The executing module 302 can calculate a second graphic angle difference between R2 and R3 use the RANSAC algorithm, and correct R3 based on the second graphic angle difference so that the graphic angles of R2 and R3 are the same.

The executing module 302 fuses of depth information on the third processed RGB images with the plurality of depth images, thereby obtains a plurality of fused images.

Each fused image of the plurality of fused images refers to a third processed RGB image that is fused with depth information of a corresponding depth image. That is, the fused image contains both depth information and color information.

In this embodiment, the executing module 302 may overlap the pixel value of each third processed RGB image and the depth value of the corresponding depth image by 1:1. The corresponding depth image is the depth image corresponding to the third processed RGB image.

For example, assuming that coordinates of a pixel point p1 of the third processed RGB image is (xx1, yy1), and a depth value of the pixel point p1 of the corresponding depth image is d, when the pixel value of the third processed RGB image and the depth value of the corresponding depth image are overlapped 1:1, the coordinates of the pixel point p1 of the fused image is (xx1, yy1, d). That is, xx1 is an abscissa of the pixel point p1 of the fused image, yy1 is an ordinate of the pixel point p1 of the fused image, and d is a vertical coordinate of the pixel point p1 of the fused image.

The executing module 302 constructs a three-dimensional map based on the plurality of fused images, and stores the three-dimensional map. For example, the three-dimensional map is stored in a storage device of the computer device.

In an embodiment, the executing module 302 may construct the three-dimensional map based on the depth information of each of the plurality of fused images.

In an embodiment, the construction of the three-dimensional map based on the plurality of fused images includes (a1)-(a2):

(a1) calculating three-dimensional coordinates of each pixel point of each fused image of the plurality of fused images in a physical space.

In an embodiment, the three-dimensional coordinates of each pixel point of each fused image in the physical space refer to the coordinates of each pixel point of each fused image in a coordinate system of the physical space.

In this embodiment, the executing module 302 establishes the coordinate system of the physical space, including: setting a position of the depth camera module as an origin O, setting a horizontal direction towards right as an X axis, setting a vertical direction upwards as a Z axis, and setting a direction vertical to a XOZ plane as a Y axis.

In this embodiment, the executing module 302 can calculate the three-dimensional coordinates of each pixel point of each fused image in the physical space using the principle of Gaussian optics.

For example, it is assumed that the coordinates of the pixel point p1 of the fused image is (xx1, yy1, d), and the coordinates of the pixel point p1 of the coordinate system of the physical space is (x1, y1, z1). Suppose that a focal length of the RGB camera of depth camera module on the x-axis of the coordinate system is fx, and the focal length of the RGB camera of depth camera module on the y-axis is fy; and a distance from a center of an aperture of the RGB camera of depth camera module to the x-axis is cx, a distance from the center of the aperture of the RGB camera of depth camera module to the y axis is cy; and a zoom value of the RGB camera of depth camera module is s. That is, fx, fy, cx, cy, s are all known values. Then z1=d/s; x1=(xx1−cx)*z1/fx; y1=(yy1−cy)*z1/fy. Thus, the three-dimensional coordinates of each pixel point of each fused image in the physical space can be calculated.

(a2) associating each fused image with the three-dimensional coordinates of each pixel point of the each fused image, and stitching the plurality of fused images, thereby obtaining the three-dimensional map.

In one embodiment, the executing module 302 may stitch the plurality of fused images using a method based on features, a method based on stream, and a method based on phase correlation.

The executing module 302 controls the robotic arm to grasp objects and place objects based on the three-dimensional map.

In this embodiment, the method for controlling the robotic arm to grasp and place objects based on the three-dimensional map can refer to the below description of FIG. 2.

The function of each module of the control system 30 further will be described in detail below from the aspect of controlling the robotic arm to grasp and place an object.

The executing module 302 determines whether the three-dimensional map has been obtained.

Specifically, the executing module 302 can query whether the three-dimensional map exists in the storage device of the computer device.

When the three-dimensional map has not been obtained, the obtaining module 301 controls the depth camera module of the robotic arm to capture images, and the executing module 302 constructs the three-dimensional map based on the captured images.

Specifically, the method of constructing the three-dimensional map is described in FIG. 1, i.e., the blocks S1 to S6 shown in FIG. 1.

When the three-dimensional map has been obtained, the executing module 302 locates position coordinates of the robotic arm based on the three-dimensional map.

In an embodiment, the executing module 302 may use a preset algorithm such as a particle algorithm (Particle Filter), a Monte-Carlo method to estimate the position coordinates of the robotic arm in the three-dimensional map.

It should be noted that the particle algorithm is an algorithm based on the Monte-Carlo method. Specifically, each particle is used to represent an estimated posture visually seen on the three-dimensional map. When the robotic arm moves visually, it uses graphical feature point comparison to assign different weights to different particles. The wrong particle has a low weight and the correct particle has a high weight. After continuous recursive operations and re-sampling, patterns with high eigenvalues will be compared, and patterns with low eigenvalues will disappear (converge). Thus, the position coordinates of the robotic arm on the three-dimensional map are found. In other words, the executing module 302 can use the Particle Filter and Monte-Carlo to estimate the position coordinates of the robotic arm in the three-dimensional map.

The executing module 302 obtains first position coordinates of a target object. The first position coordinates are coordinates of a current position of the target object.

In this embodiment, the target object is an object that is to be grasped by the robotic arm, and is to be placed in another location after being grasped by the robotic arm. The first position coordinates of the target object are coordinates in the three-dimensional map. The first position coordinates of the target object may be stored in the storage device of the executing module 302 in advance. Therefore, when the target object needs to be grasped, the executing module 302 can directly read the first position coordinates of the target object from the storage device.

The executing module 302 controls the robotic arm to grasp the target object based on the position coordinates of the robotic arm and the first position coordinates of the target object.

The executing module 302 controls the robotic arm to move from the position of the robotic arm to the position of the target object, and then controls the robotic arm to grasp the target object.

The executing module 302 determines whether the robotic arm successfully grasps the target object.

Specifically, the executing module 302 can determine whether the robotic arm successfully grasps the target object according to a weight detected by a force sensor on the robotic arm.

When the robotic arm fails to grasp the target object, the executing module 302 recognizes the target object and measures position coordinates of the target object, and obtains measured position coordinates of the target object.

Specifically, the executing module 302 may control the robotic arm to drive the depth camera module, and control the depth camera module to take a photo of the target object based on the first position coordinates of the target object, and identify the target object from the photo use a template matching method. The executing module 302 may further use a template matching method to match the target object with the three-dimensional map, thereby identifying the target object in the three-dimensional map and obtaining the position coordinates of the target object in the three-dimensional map. The position coordinates of the target object in the three-dimensional map are used as measured position coordinates of the target object.

The executing module 302 controls the robotic arm to grasp the target object based on the measured position coordinates of the target object.

When the robotic arm successfully grasps the target object, the executing module 302 obtains second position coordinates of the target object. The second position coordinates are coordinates of a target position where the target object needs to be placed.

The executing module 302 controls the robotic arm to place the target object based on the second position coordinates of the target object.

The executing module 302 determines whether the robotic arm successfully places the target object to the target position.

Similarly, the executing module 302 can determine whether the robot arm successfully places the target object to the target position according to the weight detected by the force sensor of the robotic arm.

When the robotic arm fails to place the target object to the target position, the executing module 302 adjusts the second position coordinates, and controls the robotic arm to place the target object based on the adjusted second position coordinates.

In an embodiment, the executing module 302 may adjust the second position coordinates according to a user operation signal. That is, the second position coordinates are adjusted according to user's input.

FIG. 4 shows a schematic block diagram of one embodiment of a computer device 3 and a robotic arm 4. In an embodiment, the computer device 3 may include, but is not limited to, a storage device 31, at least one processor 32, and at least one communication bus 33. The robotic arm 4 includes, but is not limited to, a depth camera module (stereo vision or Lidar with RGB camera) 41 and a force sensor 42. The depth camera module 41 includes a RGB camera and a depth camera. In one embodiment, the computer device 3 and the robotic arm 4 may establish a communication connection through wireless communication or wired communication.

It should be understood by those skilled in the art that the structure of the computer device 3 and the robotic arm 4 shown in FIG. 4 does not constitute a limitation of the embodiment of the present disclosure. The computer device 3 and the robotic arm 4 may further include other hardware or software, or the computer device 3 and the robotic arm 4 may have different component arrangements. For example, the computer device 3 may also include communication equipment such as a WIFI device and a Bluetooth device. The robotic arm 4 may also include a clamp and the like.

In at least one embodiment, the computer device 3 may include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the computer device 3 is merely an example, and other existing or future electronic products may be included in the scope of the present disclosure, and are included in the reference.

In some embodiments, the storage device 31 can be used to store program codes of computer readable programs and various data, such as the control system 30 installed in the computer device 3, and automatically access to the programs or data with high speed during the running of the computer device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 3 that can be used to carry or store data.

In some embodiments, the at least one processor 32 may be composed of an integrated circuit, for example, may be composed of a single packaged integrated circuit, or a plurality of integrated circuits of same function or different functions. The at least one processor 32 can include one or more central processing units (CPU), a microprocessor, a digital processing chip, a graphics processor, and various control chips. The at least one processor 32 is a control unit of the computer device 3, which connects various components of the computer device 3 using various interfaces and lines. By running or executing a computer program or modules stored in the storage device 31, and by invoking the data stored in the storage device 31, the at least one processor 32 can perform various functions of the computer device 3 and process data of the computer device 3. For example, the function of constructing a three-dimensional map and a function of controlling the robotic arm to grasp and place objects.

Although not shown, the computer device 3 may further include a power supply (such as a battery) for powering various components. Preferably, the power supply may be logically connected to the at least one processor 32 through a power management device, thereby, the power management device manages functions such as charging, discharging, and power management. The power supply may include one or more a DC or AC power source, a recharging device, a power failure detection circuit, a power converter or inverter, a power status indicator, and the like. In at least one embodiment, as shown in FIG. 3, the at least one processor 32 can execute various types of applications (such as the control system 30) installed in the computer device 3, program codes, and the like. For example, the at least one processor 32 can execute the modules 301-302 of the control system 30.

In at least one embodiment, the storage device 31 stores program codes. The at least one processor 32 can invoke the program codes stored in the storage device to perform functions. For example, the modules described in FIG. 3 are program codes stored in the storage device 31 and executed by the at least one processor 32, to implement the functions of the various modules for the purpose of realizing the constructing the three-dimensional map as described in FIG. 1 and the purpose of realizing the controlling the robotic arm to grasp and place objects as described in FIG. 2.

In at least one embodiment, the storage device 31 stores one or more instructions (i.e., at least one instruction) that are executed by the at least one processor 32 to achieve the purpose of realizing the constructing the three-dimensional map as described in FIG. 1 and the purpose of realizing the controlling the robotic arm to grasp and place objects as described in FIG. 2.

In at least one embodiment, the at least one processor 32 can execute the at least one instruction stored in the storage device 31 to perform the operations of as shown in FIG. 1 and FIG. 2.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A method of controlling a robotic arm to grasp and place objects comprising:
obtaining a plurality of sets of images, the plurality of sets of images comprising a plurality of RGB images and a plurality of depth images taken by a depth camera module of the robotic arm, and each set of the plurality of sets of images comprises one RGB image and one depth image;
associating the one RGB image with the one depth image of the each set of the plurality of sets of images;
processing the plurality of RGB images by a preset image processing algorithm;
fusing of depth information on the processed RGB images based on the depth information of the plurality of depth images to obtain a plurality of fused images;
constructing a three-dimensional map based on the plurality of fused images; and
controlling the robotic arm to grasp objects and place objects based on the three-dimensional map.

2. The method as claimed in claim 1, wherein the processing the plurality of RGB images by a preset image processing algorithm comprising:
performing a first processing on the plurality of RGB images to obtain first processed RGB images, wherein the first processing comprises: performing feature point matching on each two adjacent RGB images of the plurality of RGB images using a SURF algorithm;
performing a second processing on the first processed RGB images to obtain second processed RGB images, wherein the second processing comprises: confirming whether the feature point matching has been correctly performed on each two adjacent RGB images of the first processed RGB images, and eliminating wrongly matched feature point; and
performing a third processing on the second processed RGB images to obtain third processed RGB images, wherein the third processing comprises: calculating a graphic angle difference of each two adjacent RGB images of the second processed RGB images using a RANSAC algorithm, and making the graphic angle of each two adjacent RGB images the same by correspondingly correcting one of the each two adjacent RGB images based on the graphic angle difference.

3. The method as claimed in claim 1, wherein the constructing a three-dimensional map based on the plurality of fused images comprises:
calculating three-dimensional coordinates of each pixel point of each fused image of the plurality of fused images in a physical space;
associating each fused image with the three-dimensional coordinates of each pixel point of the each fused image, and stitching the plurality of fused images to obtain the three-dimensional map.

4. The method as claimed in claim 3, wherein the three-dimensional coordinates of each pixel point p1 of the each fused image is (x1, y1, z1), z1=d/s; x1=(xx1−cx)*z1/fx; y1=(yy1−cy)*z1/fy; xx1 representing an abscissa of the pixel point p1 in the fused image, yy1 representing an ordinate of the pixel point p1 in the fused image, and d representing a vertical coordinate of the pixel point p1 in the fused image; fx representing a focal length of the RGB camera of depth camera module on an x-axis of the coordinate system, and fy representing the focal length of the RGB camera of depth camera module on a y-axis; and cx representing a distance from a center of an aperture of the RGB camera of depth camera module to the x-axis, cy representing a distance from the center of the aperture of the RGB camera of depth camera module to the y axis; and s representing a zoom value of the RGB camera of depth camera module.

5. The method as claimed in claim 4, wherein the controlling the robotic arm to grasp objects and place objects based on the three-dimensional map comprises:
locating position coordinates of the robotic arm based on the three-dimensional map, when the three-dimensional map obtained;
obtaining first position coordinates of a target object, wherein the first position coordinates are coordinates of a current position of the target object;
controlling the robotic arm to grasp the target object based on the position coordinates of the robotic arm and the first position coordinates of the target object;
obtaining second position coordinates of the target object, wherein the second position coordinates are coordinates of a target position where the target object needs to be placed; and
controlling the robotic arm to place the target object on the target position based on the second position coordinates of the target object.

6. The method as claimed in claim 5, wherein the controlling the robotic arm to grasp objects and place objects based on the three-dimensional map further comprises:
determining whether the robotic arm grasps the target object based on the position coordinates of the robotic arm and the first position coordinates of the target object;
recognizing the target object and measuring position coordinates of the target object when the robotic arm fails to grasp the target object; and
controlling the robotic arm to grasp the target object based on the measured position coordinates of the target object.

7. A computer device comprising:
a storage device;
at least one processor; and
the storage device storing one or more programs, which when executed by the at least one processor, cause the at least one processor to:
obtain a plurality of sets of images, wherein the plurality of sets of images comprise a plurality of RGB images and a plurality of depth images taken by a depth camera module of a robotic arm, and each set of the plurality of sets of images comprises one RGB image and one depth image;
associate the one RGB image with the one depth image of the each set of the plurality of sets of images;
process the plurality of RGB images by a preset image processing algorithm;
fuse of depth information on the processed RGB images based on the depth information of the plurality of depth images, to obtain a plurality of fused images;
construct a three-dimensional map based on the plurality of fused images; and
control the robotic arm to grasp objects and place objects based on the three-dimensional map.

8. The computer device as claimed in claim 7, wherein the processing the plurality of RGB images by a preset image processing algorithm comprising:
performing a first processing on the plurality of RGB images to obtain first processed RGB images, wherein the first processing comprises: performing feature point matching on each two adjacent RGB images of the plurality of RGB images using a SURF algorithm;
performing a second processing on the first processed RGB images to obtain second processed RGB images, wherein the second processing comprises: confirming whether the feature point matching has been correctly performed on each two adjacent RGB images of the first processed RGB images, and eliminating wrongly matched feature point; and
performing a third processing on the second processed RGB images to obtain third processed RGB images, wherein the third processing comprises: calculating a graphic angle difference of each two adjacent RGB images of the second processed RGB images using a RANSAC algorithm, and making the graphic angle of each two adjacent RGB images the same, by correspondingly correcting one of the each two adjacent RGB images based on the graphic angle difference.

9. The computer device as claimed in claim 7, wherein the constructing a three-dimensional map based on the plurality of fused images comprises:
calculating three-dimensional coordinates of each pixel point of each fused image of the plurality of fused images in a physical space;
associating each fused image with the three-dimensional coordinates of each pixel point of the each fused image, and stitching the plurality of fused images to obtain the three-dimensional map.

10. The computer device as claimed in claim 9, wherein the three-dimensional coordinates of each pixel point p1 of the each fused image is (x1, y1, z1), z1=d/s; x1=(xx1−cx)*z1/fx; y1=(yy1−cy)*z1/fy; xx1 representing an abscissa of the pixel point p1 in the fused image, yy1 representing an ordinate of the pixel point p1 in the fused image, and d representing a vertical coordinate of the pixel point p1 in the fused image; fx representing a focal length of the RGB camera of depth camera module on an x-axis of the coordinate system, and fy representing the focal length of the RGB camera of depth camera module on a y-axis; and cx representing a distance from a center of an aperture of the RGB camera of depth camera module to the x-axis, cy representing a distance from the center of the aperture of the RGB camera of depth camera module to the y axis; and s representing a zoom value of the RGB camera of depth camera module.

11. The computer device as claimed in claim 10, wherein the controlling the robotic arm to grasp objects and place objects based on the three-dimensional map comprises:
locating position coordinates of the robotic arm based on the three-dimensional map, when the three-dimensional map obtained;
obtaining first position coordinates of a target object, wherein the first position coordinates are coordinates of a current position of the target object;
controlling the robotic arm to grasp the target object based on the position coordinates of the robotic arm and the first position coordinates of the target object;
obtaining second position coordinates of the target object, wherein the second position coordinates are coordinates of a target position where the target object needs to be placed; and
controlling the robotic arm to place the target object on the target position based on the second position coordinates of the target object.

12. The computer device as claimed in claim 11, wherein the controlling the robotic arm to grasp objects and place objects based on the three-dimensional map further comprises:
determining whether the robotic arm grasps the target object based on the position coordinates of the robotic arm and the first position coordinates of the target object;
recognizing the target object and measuring position coordinates of the target object when the robotic arm fails to grasp the target object; and
controlling the robotic arm to grasp the target object based on the measured position coordinates of the target object.

13. A non-transitory storage medium having instructions stored thereon, when the instructions are executed by a processor of a computer device, the processor is configured to perform a method of controlling a robotic arm to grasp and place an object, wherein the method comprises:
obtaining a plurality of sets of images, wherein the plurality of sets of images comprise a plurality of RGB images and a plurality of depth images taken by a depth camera module of the robotic arm, and each set of the plurality of sets of images comprises one RGB image and one depth image;
associating the one RGB image with the one depth image of the each set of the plurality of sets of images;
processing the plurality of RGB images by a preset image processing algorithm;
fusing of depth information on the processed RGB images based on the depth information of the plurality of depth images to obtain a plurality of fused images;
constructing a three-dimensional map based on the plurality of fused images; and
controlling the robotic arm to grasp objects and place objects based on the three-dimensional map.

14. The non-transitory storage medium as claimed in claim 13, wherein the processing the plurality of RGB images by a preset image processing algorithm comprising:
performing a first processing on the plurality of RGB images to obtain first processed RGB images, wherein the first processing comprises: performing feature point matching on each two adjacent RGB images of the plurality of RGB images using a SURF algorithm;
performing a second processing on the first processed RGB images to obtain second processed RGB images, wherein the second processing comprises: confirming whether the feature point matching has been correctly performed on each two adjacent RGB images of the first processed RGB images, and eliminating wrongly matched feature point; and
performing a third processing on the second processed RGB images to obtain third processed RGB images, wherein the third processing comprises: calculating a graphic angle difference of each two adjacent RGB images of the second processed RGB images using a RANSAC algorithm, and making the graphic angle of each two adjacent RGB images the same, by correspondingly correcting one of the each two adjacent RGB images based on the graphic angle difference.

15. The non-transitory storage medium as claimed in claim 13, wherein the constructing a three-dimensional map based on the plurality of fused images comprises:
calculating three-dimensional coordinates of each pixel point of each fused image of the plurality of fused images in a physical space;
associating each fused image with the three-dimensional coordinates of each pixel point of the each fused image, and stitching the plurality of fused images to obtain the three-dimensional map.

16. The non-transitory storage medium as claimed in claim 15, wherein the three-dimensional coordinates of each pixel point p1 of the each fused image is (x1, y1, z1), z1=d/s; x1=(xx1−cx)*z1/fx; y1=(yy1−cy)*z1/fy; xx1 representing an abscissa of the pixel point p1 in the fused image, yy1 representing an ordinate of the pixel point p1 in the fused image, and d representing a vertical coordinate of the pixel point p1 in the fused image; fx representing a focal length of the RGB camera of depth camera module on an x-axis of the coordinate system, and fy representing the focal length of the RGB camera of depth camera module on a y-axis; and cx representing a distance from a center of an aperture of the RGB camera of depth camera module to the x-axis, cy representing a distance from the center of the aperture of the RGB camera of depth camera module to the y axis; and s representing a zoom value of the RGB camera of depth camera module.

17. The non-transitory storage medium as claimed in claim 16, wherein the controlling the robotic arm to grasp objects and place objects based on the three-dimensional map comprises:
locating position coordinates of the robotic arm based on the three-dimensional map, when the three-dimensional map obtained;
obtaining first position coordinates of a target object, wherein the first position coordinates are coordinates of a current position of the target object;
controlling the robotic arm to grasp the target object based on the position coordinates of the robotic arm and the first position coordinates of the target object;
obtaining second position coordinates of the target object, wherein the second position coordinates are coordinates of a target position where the target object needs to be placed; and
controlling the robotic arm to place the target object on the target position based on the second position coordinates of the target object.

18. The non-transitory storage medium as claimed in claim 17, wherein the controlling the robotic arm to grasp objects and place objects based on the three-dimensional map further comprises:
determining whether the robotic arm grasps the target object based on the position coordinates of the robotic arm and the first position coordinates of the target object;
recognizing the target object and measuring position coordinates of the target object when the robotic arm fails to grasp the target object; and
controlling the robotic arm to grasp the target object based on the measured position coordinates of the target object.
